(19) United States
(12) Patent Application Publication
(10) Pub. No.: US 2012/0115045 A1
(43) Pub. Date: May 10, 2012

(54) MICROBIAL FUEL CELL

(76) Inventors: Piyush Kumar R. KAPOPARA, Chennai (IN); Mrityunjay Kumar Singh, Chennai (IN); Vinayak Gupta, Chennai (IN); Hemant Giri, Chennai (IN); Ramesh Chandra Pandey, Chennai (IN)

(21) Appl. No.: 13/014,799

(22) Filed: Jan. 27, 2011

(30) Foreign Application Priority Data
Nov. 4, 2010 (IN) 3295/CHE/2010

(51) Int. Cl. H01M 8/16

(52) U.S. Cl. 429/401

(57) ABSTRACT

Disclosed herein are methods and devices for generating electricity from an effluent source. In the presence of a biological catalyst, a high strength effluent allows for efficient production of electricity. Further, disclosed herein are methods for the treatment of wastewater while generating electricity.

### CROSS-REFERENCE TO RELATED APPLICATIONS

This application claims the benefit of Indian Application No. 3295/CHE/2010, filed on Nov. 4, 2010, which is hereby incorporated by reference, in its entirety, for any and all purposes.

### TECHNICAL FIELD

This disclosure relates generally to a fuel cell for the generation of electricity. Specifically, this disclosure relates to a microbial fuel cell (MFC) that employs wastewater as an effluent source. Also included are methods for generating electricity while concomitantly treating wastewater.

### BACKGROUND

The following description is provided to assist the understanding of the reader. None of the information provided or references cited is admitted to be prior art.

A fuel cell is an electrochemical unit that converts chemical energy into an electrical current. The electric current is generated through chemical reactions using a substrate, i.e., a fuel, that is oxidized in the presence of an electron producing catalyst. The oxidation typically occurs at an anode proximal to an electrolyte medium. The electrons cannot pass through the electrolyte medium, and thus, are shunted through an electrical circuit. Hence, an electrical current is generated by the transfer of electrons from an anode to a cathode. The reaction products are formed at the cathode.

Fuel cells can operate continuously by maintaining a constant source of chemical reactants. Accordingly, fuel cells are different from electrochemical batteries because fuel cells require reactants, from an external source, that can be replenished, i.e., a thermodynamically open system. Electrochemical batteries, however, produce an electrical current from an internal, thermodynamically closed system.

A replenishable, open system requires a fuel source and an oxidizing agent. For example, hydrogen fuel cells employ hydrogen as the source and oxygen as an oxidizing agent. Hydrogen fuel cells typically produce water as the reaction product. However, if an oxygen and a hydrocarbon, e.g., methane, methanol, ethanol, etc., are employed as the oxidizing agent and the fuel source, respectively, the reaction products are typically water and carbon dioxide (CO₂).

### SUMMARY

In one aspect, the present disclosure generally describes an apparatus, and methods related thereto, for generating electricity comprising a first compartment configured for receiving an effluent source and including one or more cellulolytic enzymes, and a second compartment having an electrochemical cell and a biocatalyst capable of oxidizing the effluent, wherein the first compartment is in fluid communication with the second compartment. In one embodiment, the effluent contains cellulosic biomass from wastewater.

In one embodiment, the one or more cellulolytic enzymes are selected from the group consisting of endoglucanase, cellulase, xylanase, and β-glucosidase. In one embodiment, the one or more cellulolytic enzymes are immobilized within the first compartment. In one embodiment, the electrochemical cell contains one or more anodes and at least one cathode connected to an electrical circuit.

In one embodiment, one or more anodes are carbon cloth anodes or graphite felt anodes, or both. In one embodiment, at least one cathode is an air-cathode. In one embodiment, the second compartment is an anaerobic compartment. In one embodiment, the biocatalyst is capable of forming a biofilm. In one embodiment, the biocatalyst is bacteria. In one embodiment, the bacteria are responsive to quorum-sensing inducers.

In one embodiment, the bacteria are Rhodoferax sp. bacteria or Geobacter sp. bacteria or both. In one embodiment, the bacteria are selected from the group consisting of G. sulfurreducens and R. ferrireducens, or any combination thereof. In one embodiment, the apparatus further comprises a proton exchange membrane. In one embodiment, the apparatus further comprises a proton exchange membrane.

In one aspect, the present disclosure generally describes a method for generating electricity comprising passing an effluent through a first compartment including one or more cellulolytic enzymes, and allowing the effluent to flow into a second compartment that includes an electrochemical cell and a biocatalyst capable of oxidizing the effluent, thereby producing the electricity.

In one embodiment of the method, one or more cellulolytic enzymes are selected from the group consisting of endoglucanase, cellulase, xylanase, and β-glucosidase, or any combination thereof. In one embodiment of the method, one or more cellulolytic enzymes are immobilized within the first compartment. In one embodiment of the method, the electrochemical cell contains one or more anodes and at least one cathode connected to an electrical circuit.

In one embodiment of the method, one or more anodes are carbon cloth anodes or graphite felt anodes, or both. In one embodiment of the method, at least one cathode is an air-cathode. In one embodiment of the method, the second compartment is an anaerobic compartment. In one embodiment of the method, the biocatalyst is capable of forming a biofilm. In one embodiment of the method, the biocatalyst is bacteria. In one embodiment of the method, the bacteria are responsive to quorum-sensing inducers.

In one embodiment of the method, the bacteria are Rhodoferax sp. bacteria or Geobacter sp. bacteria or both. In one embodiment of the method, the bacteria are selected from the group consisting of G. sulfurreducens and R. ferrireducens, or any combination thereof. In one embodiment, the method further comprises a proton exchange membrane.

### BRIEF DESCRIPTION OF THE FIGURES

FIG. 1 is a schematic diagram showing an illustrative embodiment of a two compartment microbial fuel cell. The first compartment contains enzymes for producing a high strength effluent and a second compartment that generates electricity.

FIG. 2 is a flow chart demonstrating the process of generating electricity from a microbial fuel cell while simultaneously treating wastewater.

### DETAILED DESCRIPTION

In the following detailed description, reference may be made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made without departing from the spirit or scope of the subject matter presented herein.

As used herein, unless otherwise stated, the singular forms “a,” “an,” and “the” include plural reference. Thus, for example, a reference to “a bacteria” includes one or more bacterial cells.

As used herein, the term “about” will be understood by persons of ordinary skill in the art and will vary to some extent depending upon the context in which it is used. If there are uses of the term which are not clear to persons of ordinary skill in the art, given the context in which it is used, the term “about” in reference to quantitative values will mean up to plus or minus 10% of the enumerated value.

As used herein, the term “aerobic” or “aerobic conditions” refers to conditions in a compartment or compartments that contain an amount of oxygen. Aerobic conditions may refer to the environment in second compartment during an oxidation reaction.

As used herein, the term “anaerobic” or “anaerobic conditions” refer to conditions where oxygen is absent. Typically, anaerobic conditions refer to an environment where only anaerobic microorganisms can survive. Anaerobic conditions may refer to the environment in a second compartment during an oxidation reaction.

As used herein, the term “biofilm” or “biofilms” refers to refers to an aggregate of living cells which are connected and/or immobilized onto a surface as microbial colonies. The cells are typically embedded within a self-secreted matrix of extracellular polymeric substance (EPS), which is a polymeric sticky mixture of nucleic acids, proteins and polysaccharides. Biofilms may form on living, non-living, organic, or inorganic substrates, and constitute a prevalent mode of microbial life in natural, industrial, and hospital settings. Biofilms can be cells of a unicellular microorganism, i.e., prokaryotes, archaea, bacteria, eukaryotes, protists, fungi, algae, euglena, protozoan, dinoflagellates, apicomplexa, trypanosomes, amoebae, and the like.

As used herein, the terms “cellulase”, “cellulases”, or “cellulolytic enzymes”, refers to enzymes that catalyze the hydrolysis of cellulose. Cellulases are primarily produced by fungi, bacteria, and protozoans. Other cellulases, produced by various other organisms, such as, but not limited to, plants and animals are also well known in the art. Some examples of cellulases, include, but are not limited to, endoglucanase, cellulase, xylanase, and β-glucosidase, or any combination thereof.

As used herein, the term “cellulose” refers to a polysaccharide of beta-glucose that has the formula (C₆H₁₀O₅)n. Cellulose forms the primary structural component of green plants. The primary cell wall of green plants is made of cellulose; the secondary wall contains cellulose with variable amounts of lignin. “Hemicelluloses” as used herein, refers to a mixture of polysaccharides composed primarily of polymers of xylose, arabinose or galactose, and the like, or any combination thereof

As used herein, the terms “cellulosic biomass” or “cellulosic feedstock” refers to materials that contain cellulose. The materials include, but are not limited to, wastewater, wastewater contaminants, organic matter, wood or wood waste, straw, herbaceous crops, corn stover, grass such as switch grass, or other sources of annual or perennial grass, or any delignified cellulose such as paper or paper waste, pulp and paper mill waste, municipal and industrial solid wastes.

As used herein, the terms “compartment”, “a first compartment”, “a second compartment”, etc., refer to devices or chambers that support a biologically active environment, typically a chamber capable of treating wastewater and/or allowing for substrate fermentation and degradation via microorganism metabolism. A compartment may have various environmental conditions, such as, but not limited to, gas content (e.g., air, oxygen (or lack of oxygen), nitrogen (or lack of nitrogen), carbon dioxide), flow rates, temperature, pH, humidity, intensity of light, dissolved oxygen levels, and agitation speed/circulation rate. Compartments can be of any size, shape, or material, and of any configuration that will physically maintain an effluent source capable of providing for the generation of electricity. Along these lines, acrylic compartments are suitable for smaller, laboratory scale embodiments. However, compartments made of steel may also be used in large-scale production, as these cathodes can facilitate the catalytic production of electricity, thereby decreasing the cost of production compared to other metals such as platinum. See, e.g., Strasser, et al., Lattice-strain control of the activity in dealloyed core-shell fuel cell catalysts. Nature Chemistry, Vol. 2 pp. 454-460 (2010).

As used herein, the term “effluent” refers to any wastewater, waste, water effluent, or exhaust that results from one or more processes and/or chemical reactions that is emitted by, e.g., flows from, a structure. The term “effluent” may be used interchangeably with the terms “wastewater”, “waste” and “exhaust.” The effluent may be in any suitable form, for example, gaseous effluent, liquid effluent, solid, e.g., particulate effluent, and/or any combination thereof. An effluent of the present disclosure generally contains cellulosic biomass.

As used herein, the term “high strength effluent” refers to an effluent that has reacted with one or more cellulolytic enzymes contained within at least one compartment of the present disclosure. The reaction of an effluent containing cellulosic biomass with cellulolytic enzymes forms simple sugars or other constituents that can be used by bacteria as an energy source. The “high strength” relates to the ability of the effluent to act as a high energy bacterial substrate for efficient generation of electricity within a MFC.

As used herein, the term “electricigens” refer to organisms that breakdown organic matter and transfer electrons to the surrounding environment, i.e., an anode, rather than an electron acceptor such as oxygen. Electricigens can completely oxidize organic compounds to carbon dioxide or other byproducts and then transfer the electrons derived from the oxidation onto the anode of a MFC. For example, electricigens, also called electricigenic microbes, include organisms in the family Geobacteraceae including organisms from any of the Geobacter, Desulfuromonas, Desulfuromusa, Pelobacter or Malonomonas genera that are capable of oxidizing organic fuel compounds completely to carbon dioxide and/or are capable of dissimilatory Fe(III) reduction.

As used herein, the term “electrode” refers to an anode or a cathode. The “anode” is an electrode that facilitates the oxidation, i.e., the loss of electrons, of a substrate. For example, the high strength effluent, which contains one or more saccharides, is oxidized by bacteria, i.e., electricigens, at the anode. The “cathode” is an electrode that facilitates the reduction, i.e., gaining of electrons, of an oxidant, typically oxygen.

As used herein, the term “fermentation” refers to a process of deriving energy from the oxidation of organic compounds, such as, but not limited to, carbohydrates and saccharides. For example, fermentation of carbohydrates or saccharides, such as, but not limited to glucose and sucrose, occur indirectly though an electron acceptor at the anode.

As used herein, the terms “immobilizing” or “immobilized” refer to the ability to retain a protein, polypeptide, microbe, or any combination thereof, in or on a matrix, surface, particle, or bead containing a matrix. In one embodiment, methods for enzyme immobilizing include, but are not limited to, adsorption, covalent binding, entrapment, membrane confinement, and cross-linking.

As used herein, the term “treatment”, “treating”, or “treated” refers to the degradation of organic compounds within wastewater. As disclosed herein, wastewater treatment requires the removal or degradation of organic material, i.e., cellulosic biomass, to yield end products including treated wastewater and sludge. An effluent may be treated to produce a high strength effluent through the process described above, i.e., degradation of organic material. A high strength effluent may be further “treated” in the presence of bacteria capable of breaking down organic constituents within the high strength effluent.

The present disclosure relates generally to microbial fuel cells (MFCs) for the generation of electricity, and methods therefor. An effluent source, such as wastewater, may be provided as a continuously replenishable fuel supply. For example, the wastewater may be treated, i.e., organic impurities are degraded, as it concomitantly provides a continuous fuel source. In one embodiment, the treated wastewater is a high strength effluent, i.e., an efficient MFC substrate. Accordingly, the present disclosure relates to the generation of electricity while simultaneously treating wastewater.

Wastewater treatment is energy-expensive and current MFCs are not effective for generating electricity from a wastewater source for a number of reasons. Cellulose and other wastewater constituents are unsuitable for MFC bacterial fermentation because they impart a non-efficacious effluent, thereby making the generation of electricity inefficient. Further, sub-optimal electron densities at the electrode, lack of sufficient surface area for microbial growth, poor electron transport at the anode, and the production of carbon dioxide, are infirmities that currently stymie the advance of MFC technology.

Typically, wastewater is treated by degrading inorganic and/or organic impurities via chemicals or by physical removal of the unwanted particulates. Wastewater impurities, however, can also function as a MFC fuel source in the form of cellulosic biomass. To this point, cellulosic biomass, when broken down into simple sugars or other constituents, can be used by bacteria as an energy source. Thus, cellulosic biomass contained within the wastewater is an important constituent of an effluent source that drives MFC electricity production. Accordingly, wastewater can be employed as a continuous effluent source for the generation of electricity through a MFC.

In one aspect, the present disclosure generally describes an economically- and environmentally-friendly MFC apparatus. The apparatus of the present disclosure includes a first compartment for generating a high strength effluent. In one embodiment, the first compartment includes cellulases, i.e., cellulolytic enzymes, which react with the cellulosic biomass contained in an effluent, i.e., cellulolytic hydrolysis. In one embodiment, subsequent to the cellulolytic hydrolysis, a high strength effluent is produced. In one embodiment, the high strength effluent contains degraded cellulosic biomass. In one embodiment, cellulolytic hydrolysis degrades organic impurities in wastewater while producing a high strength effluent. In this regard, high strength effluent, as compared to a standard cellulose-based effluent, decreases the metabolic load of the bacterial electricigens by supplying a readily metabolizable energy source, e.g., simple sugars such as glucose.

The MFC apparatus may include a second compartment for generating electricity by using the high strength effluent as a substrate, i.e., fuel. In one embodiment, the second compartment contains a electrochemical cell capable of generating an electrical current between one or more anodes and at least one cathode. In one embodiment, one or more anodes and at least one cathode are connected to an electrical circuit. In one embodiment, one or more anodes have large enough surface areas to provide for sufficient electron generation and capture. In one embodiment, sufficient electron capture occurs in the presence of a biocatalyst capable of biofilm formation. In one embodiment, the biocatalyst is bacteria. In one embodiment, the bacteria are electricigens, i.e., microbes that can completely oxidize organic compounds to carbon dioxide and then transfer the electrons derived from the oxidation directly to the MFC anode. See, e.g., Lovely, D., Taming Electricigens: How electricity-generating microbes can keep going, and going—faster. The Scientist, Fuel Cells, p. 46 (2006). In one embodiment, the bacteria degrade organic impurities in the high strength effluent. Accordingly, the MFC apparatus simultaneously treats wastewater while also generating electricity.

In one embodiment, a high strength effluent is the substrate for an oxidation reaction in the presence of bacterial electricigens. Accordingly, the production of a high strength effluent in the first compartment provides the substrate for the oxidation reaction in the second compartment. Consequently, electricity is generated by the electrochemical cell from the oxidation of a high strength effluent by bacterial biocatalysts, i.e., electricigens.

In one embodiment, the apparatus contains a first compartment that receives a continuous effluent source. The effluent may contain cellulosic biomass which can be degraded or broken-down into saccharide components, e.g., monosaccharides and disaccharides, or the like. The saccharide components can then be used as an energy source for fermentation, electron transport, and/or electricigen metabolism by employing a MFC within a second compartment containing a biocatalyst. In one embodiment, the effluent source containing cellulosic biomass is wastewater. In one embodiment, the wastewater is treated in the first compartment.

The treatment of wastewater typically requires the removal or degradation of organic material, i.e., cellulosic biomass, to yield end products including treated wastewater and sludge. In one embodiment, the wastewater, i.e., the effluent, is initially treated by passing the effluent through the first compartment containing cellulolytic enzymes. The cellulolytic enzymes, i.e., cellulases, can breakdown cellulose into saccharide components. The breakdown of cellulose provides the MFC energy source while concomitantly treating the wastewater.

The cellulolytic enzymes can be produced from various microorganisms, isolated as free protein, and immobilized. Immobilization of the cellulolytic enzymes may occur through various techniques known in the art, such as, but not limited to, adsorption, covalent binding, entrapment, crosslinking, and membrane confinement. See, e.g., Divya, et al., Covalent enzyme immobilization onto glassy carbon matrix implications in biosensor design. Journal of Biosciences, Vol. 23(2): p. 131-136 (1998). These enzymes can be immobilized in the presence of appropriate matrices, e.g., a carbon matrix, which allow for lower cost while not disrupting the activity of the enzyme. In one embodiment, Trichoderma reesei, a mesophilic and filamentous fungus, is used as the source of cellulolytic enzymes. T. reesei has the capacity to secrete large volumes of cellulolytic enzymes, i.e., cellulases and hemicellulases. Other microorganisms that can produce cellulases and/or hemicellulases may also be used. Suitable species include, but are not limited to, other strains of T. reesei, Aspergillus niger, A. phoenicis, A. oryzae, A. awamori, Rhizopus oryzae, R. microsporus, Acidothermus cellulyticus, Trichoderma koningii, T viride. T. harzianum, Fusarium oxysporum, Penicillum pupurogenum, Myceliophthora sp., and Lentinous sp. See, e.g., Pandey et al., Current Science (Bangalore), 77(1): 149-163 (1999).

In one embodiment, cellulolytic enzymes, i.e., cellulases, are directly employed. Cellulases catalyze the hydrolysis of cellulose. In one embodiment, commercially available enzyme mixtures for cellulose hydrolysis are employed. For example, Accelase™ 100 enzyme complex (Genencor, Palo Alto, Calif.) contains multiple enzyme activities, including, but not limited to, exoglucase, endoglucanase, hemi-cellulase and beta-glucosidase activity. Notwithstanding commercial cellulases, several different kinds of cellulases are known in the art, which differ structurally and mechanistically. There are five general types of cellulases based on the type of reaction catalyzed: endocellulases; exocellulases; cellobiases; oxidative cellulases; and cellulose phosphorylases. In one embodiment, any of the five general types of cellulases are employed. In another embodiment, mixtures of two or more of the different types of cellulases are used. In one embodiment, cellulolytic enzymes are selected from the group consisting of endoglucanase, cellulase, xylanase, and β-glucosidase.

In one embodiment, cellulases are immobilized on a surface within the first compartment. In one embodiment, methods for enzyme immobilizing include, but are not limited to, adsorption, covalent binding, entrapment, membrane confinement, and cross-linking. In one embodiment, cellulases are immobilization by covalent binding. In one embodiment, a carbon matrix can be used as the surface cellulase immobilization. It has been demonstrated that carbon matrices allow for up to 70% enzymatic activity retention following immobilization. See Daoud, et al., Adsorption of cellulase Aspergillus niger on a commercial activated carbon: Kinetics and equilibrium studies. Colloids and Surfaces Biointerfaces. 75(1): 93-99 (2009). In one embodiment, covalent binding of cellulase to a carbon matrix can be employed for the continuous production of glucose or other organic substances from cellulose derivatives, i.e., cellulosic biomass.

A high strength effluent can be produced by treating the effluent, i.e., the wastewater, with cellulolytic enzymes. For instance, the high strength effluent may contain the products of cellulolytic hydrolysis. These products may include monosaccharides, disaccharides, or other organic substances. In one embodiment, the high strength effluent contains glucose or a derivative thereof. The glucose-containing high strength effluent can then serve as a substrate for bacterial fermentation, electron transport, and/or electricigen metabolism in the second compartment.

In one embodiment, the second compartment of the MFC apparatus includes an electrochemical cell having one or more anodes, at least one cathode, and an optional cation exchange membrane, i.e., proton exchange membrane (PEM). A proton exchange membrane is a semi-permeable polymer typically made from ionomers, i.e., polymers composed of both electrically neutral units and ionized units. The PEM is capable of conducting protons while being impermeable to gases such as oxygen or hydrogen. Consequently, the function of a PEM, when incorporated into a fuel cell, is proton transport while keeping the reactants separate. In one embodiment, an air-cathode is employed when generating electricity from a non-aqueous system. The advantage of an air-cathode, i.e., compared to a cathode submerged in water, is that oxygen transfer to the cathode occurs directly from the air. Thus, because there is no requirement for oxygen to be dissolved in water, a quicker more efficient generation of electricity is possible. In one embodiment, the PEM is employed when generating electricity from an aqueous system. In one embodiment, an anode and a cathode are connected to an electrical circuit. In one embodiment the electrical circuit is external to the second compartment.

In one embodiment, the apparatus includes a single-chamber, air-cathode within the second compartment. The single-chamber cell allows for the efficient production of power in the absence of a PEM, an expensive component of the two-chamber embodiment, which can become tainted with soluble contaminants, thereby requiring its replacement. It is contemplated that a single-chamber, air-cathode can produce at least about 100, 200, 250, or about 262 mW/m² of power when glucose is employed as the substrate. In one embodiment, at least about 262 mW/m² of power is contemplated when glucose is employed as the substrate. However, after removing the PEM from the second compartment, it is contemplated that the power generation can increase to as much as about 100, 200, 300, 400, 450, or about 494 mW/m² of power when glucose is employed as the substrate. In one embodiment, it is contemplated that the power generation can increase to as much as about 494 mW/m² of power when glucose is employed as the substrate.

In some embodiments, increasing the surface area of the electrodes may increase power output. Without wishing to be limited by theory, it is contemplated that, for example, an approximate three-fold increase in electric current can be obtained by increasing the surface area of the electrodes. For example, a surface area increase from 0.0065 m² to 0.020 m², an approximate 200% increase, may increase the electric current as described herein. It is contemplated that an increase in the surface area of the electrodes can also decrease wastewater retention times, which is important when employing a continuous effluent source. In one embodiment, at least about 10, 50, 100, 200, 300, 400, 500 or 1000 cm² of electrode surface area is contemplated. In one embodiment, at least about 200 cm² of electrode surface area is contemplated. The choice of electrode material may also effect power output. In one embodiment, graphite felt may be employed as the electrode material. In one embodiment, carbon cloth may be employed as the electrode material. In one embodiment, the electrode is the anode. In one embodiment, the electrode is the cathode.

In one aspect, a biocatalyst acts on an organic substrate, i.e., the high strength effluent, thereby producing carbon dioxide, protons, and electrons. Electrons are produced by an oxidation reaction and are concomitantly transferred to the anode by the biocatalyst. In one embodiment, the electrons cannot pass through the PEM, and thus, are directed through an electrical circuit, to the cathode. Protons simultaneously migrate through the PEM to the cathode. In one embodiment, an oxidant, such as oxygen, reacts with the protons and electrons at the cathode to form water. Accordingly, a biocatalyst, can facilitate the generation of electricity in the presence of a high strength effluent substrate.

In one embodiment, bacterial microbes act as biocatalysts for electron production. In one embodiment the biocatalysts are electricigens. In one embodiment, Rhodoferax sp. or Geobacter sp. or both are employed as the electricigens. In one embodiment, the electricigens includes one or more bacteria selected from the group consisting of G. sulfurreducens and R. ferrireducens, or any combination thereof. In one embodiment, the present disclosure contemplates employing G. sulfurreducens for the generation of electricity. In one embodiment, the present disclosure contemplates employing R. ferrireducens for the generation of electricity.

In one embodiment, R. ferrireducens is contemplated to convert at least about 20, 40, 60, or 80% of the produced electrons to an electric current by oxidation to carbon dioxide. In one embodiment, R. ferrireducens is contemplated to convert at least about 80% of the produced electrons to an electric current by oxidation to carbon dioxide. Such an efficient transfer of elections is contemplated by the present disclosure because bacterial proliferation can be supported by energy production from the electron transfer process at the anode. Accordingly, in anaerobic conditions, the transfer of electrons can occur in the absence of an electron shuttling mediator. An electron shuttling mediator, such as phenolic compounds, can be expensive, toxic, and decrease the efficiency of a MFC.

The amount or concentration of bacteria added to the single- or two-chambered compartments varies depending upon the surface area of the electrode contained therein. In suitable embodiments, single bacterial cell suspensions of at least about 1×10⁴, 1×10⁵, 1×10⁶, 1×10⁷, 1×10⁸, 1×10⁹, 1×10¹⁰, 1×10¹¹, 1×10¹² or 1×10¹³ cells/ml may be added to the single- or two-chambered compartments. In another embodiment, single cell suspensions of at least about 0.5, 1, 2, 3, 4, 5, 6, 7, 8, or 9×10⁹ or cells/ml may be added to the single- or two-chambered compartments. In one embodiment, single cell suspensions of at least about 5×10⁹ cells/ml may be added to the single- or two-chambered compartments. Cell suspensions may also be enriched with activated sludge for an increased efficiency. See Wang et al., 2010).

In one aspect, bacteria and/or electricigens are capable of communication through quorum sensing (QS). QS enables bacteria to respond to stimuli and, when induced, alter their density at one or more locations. QS is not limited to intra-species communication. However, QS typically occurs between bacteria of the same genus or species. To this point, various bacterial species typically use different molecules to communicate. QS signaling molecules, sometimes referred to as inducers, include, but are not limited to, N-Acyl Homoserine Lactones (AHL) in Gram-negative bacteria, and a family of auto-inducers known as AI-2 in both Gram-negative and Gram-positive bacteria.

One application of QS is the formation of bacterial biofilms. Bacteria are capable of forming biofilm communities on a myriad of biological and inorganic surfaces. Biofilm genetic analyses have demonstrated that it is possible for extracellular signals to alter or produce differentiated biofilms. In one embodiment, the present disclosure contemplates the use of QS molecules, signaling molecules, inducers, and the like, for the generation of bacterial biofilms. In one embodiment, the biofilms are generated at an anode within the second compartment. In one embodiment, the biofilm is capable of efficiently transferring electrons to the anode. In one embodiment, the biofilm comprises bacterial electricigens.

The basic components required for biofilm formation include: microbes; a glycocalyx; and a surface. Biofilm formation can occur in the presence of bacteria capable of producing a glycocalyx, i.e., the slime layer. The slime layer provides a protective coating to the bacteria, which is composed of exopolysaccharides and water. Further, biofilm formation is facilitated by bacterial that produce pili for adhering to surfaces and each other. In one embodiment, Geobacter sp. and Rhodoferax sp. are the bacterial species that form biofilms.

Furthermore, wastewater treatment reactors are highly porous to avoid accumulation of particulate matter. Accordingly, the thickness of the biofilm layer is important for its stability on such a porous surface. In one embodiment, the thickness of the biofilm layer is optimized to efficiently transfer electrons to one or more anodes. In one embodiment, the thickness of the biofilm may be, for example, between about 10-100 μm. In one embodiment, the thickness of the biofilm may be, for example, between about 50-100 μm.

In one aspect, bacteria and/or biofilms, including electricigens, present at the anode convert organic substrates, such as, but not limited to, glucose, acetate, and other wastewater substrates, into carbon dioxide, protons, and electrons. Under aerobic conditions, electricigens can use oxygen or nitrate as an electron acceptor, thereby producing water. However, when oxygen is absent at the anode, electricigens are conditioned to switch from their natural electron acceptor, i.e., oxygen, to an insoluble acceptor, such as the anode. Accordingly, because electricigens can directly transfer electrons to an insoluble acceptor, the present invention contemplates the generation of electricity though electricigen-mediated metabolism. In one embodiment, the second compartment operates under anaerobic conditions. To this end, electricigens proliferate and oxidize organic matter, i.e., from the high strength effluent, in the absence of oxygen. In one embodiment, the oxidation produces electrons at the anode, in the second compartment, which subsequently travel through an electrical circuit to the cathode. The migration occurs due to the charge difference created between the anode and the positively charge ions at the cathode. The electrical current is, thus, borne out of the charge difference.

Accordingly, electrical potential can be created between the cathode and the anode. In one embodiment, an apparatus is contemplated that has an electric potential between about 0.001-10V, 0.01-5V, 0.1 to 1V, or about 0.5-0.8V. In one embodiment, an apparatus is contemplated that has a potential between about 0.5-0.8V. These potentials are similar to those generated in a typical hydrogen fuel cell. One of skill in the art will readily understand that higher voltages can be obtained by connecting multiple circuits in series.

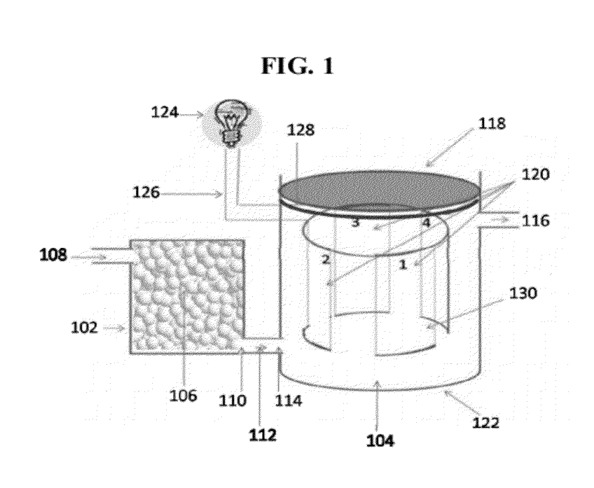

FIG. 1 shows an illustrative embodiment of the present disclosure. A first compartment 102 is in fluid communication with a second compartment 104. The first compartment 102 contains one or more cellulolytic enzymes 106 or enzyme producing cells. The cellulolytic enzymes 106 are immobilized within the first compartment. In one embodiment, the cellulolytic enzymes 106 are capable of breaking down cellulose into a bacterial substrate. The first compartment 102 further includes an inflow 108 through which the effluent is introduced. The first compartment 102 also contains an effluent outflow 110.

As shown in FIG. 1, the first compartment 102 is in fluid communication with the second compartment 104 via a connector 112. The connector 112 can be a pipe, a conduit, tubing, or any other suitable connecting device. The size and width of the connector 112, which optionally includes a valve, can be selected for a desired flow rate. The second compartment 104 includes an inflow 114 operatively connected to the connector 112 and an outflow 116 through which reaction products, i.e., treated wastewater, can exit the second compartment 104.

The second compartment 104 includes at least one cathode 118 and one or more anodes 120. The cathode 118 can be an air-cathode, and the one or more anodes may include four electrode surfaces 1-4 as shown. The cathode 118 can be a carbon cathode, a platinum coated carbon cathode, or composed of any material typically used in the art. In one embodiment, the air-cathode and the one or more anodes 120 allow for efficient generation of electrons. The MFC further includes a second compartment with an outer casing 122. An external circuit 124 can be connected to the MFC though electrical wires 126. In one embodiment, a proton exchange membrane (PEM) is included 128.

Further, the one or more anodes 120 may be composed of carbon cloth or graphite felt. The carbon cloth or graphite felt can provide a large surface area for biofilm 130 formation. In one embodiment, an air-cathode 118 is employed in the absence of a proton exchange membrane 128. If sufficient conductivity between one or more anodes 120 and the cathode 118 is present, a PEM 128 can be excluded.

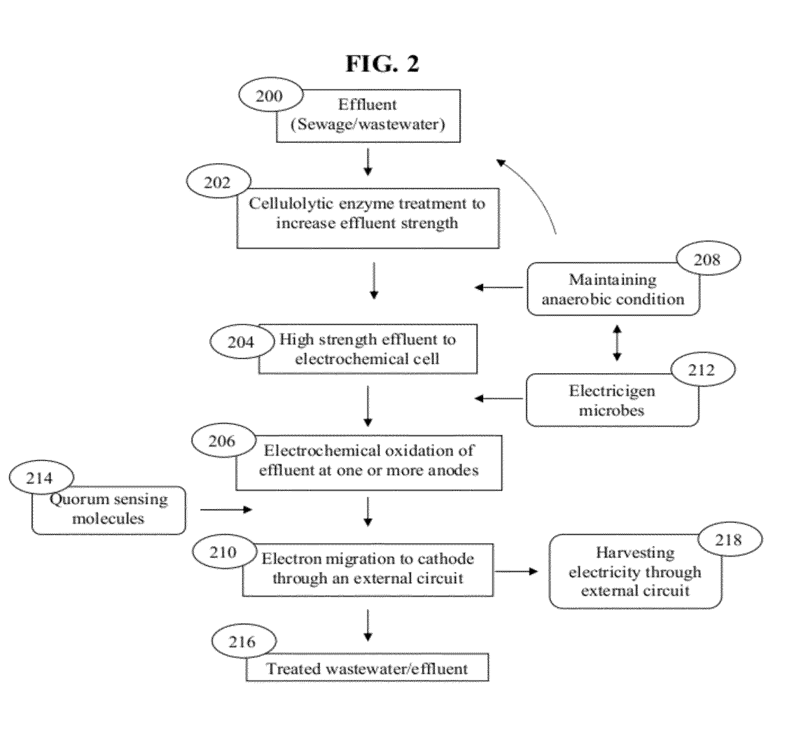

FIG. 2 shows a flow chart of an illustrative embodiment of the treatment and energy generation process of the present disclosure. In an operation 200, effluent such as but not limited to sewage or wastewater is received. In an operation 202, wastewater effluent from the operation 200 is treated with cellulolytic enzymes to increase the strength of the effluent.

In an operation 204, the high strength effluent from the operation 202 passes to an electrochemical cell. In an operation 206, the high strength effluent from the operation 204 is electrochemically oxidized at one or more anodes. The cellulolytic treatment of the effluent imparts MFC electricity generation whereas in the absence of such treatment, the effluent would not contain a sufficient concentration of the bacterial substrate, i.e., biofuel. Effluent treatment may be accomplished by exposing raw effluent to one or more cellulolytic enzymes. The cellulolytic enzymes may be immobilized on a surface within the first compartment. The effluent can also be exposed to various enzymes with polysaccharide degrading activity, such as, but not limited to, α-galactosidases, β-galactosidases, β-glucosidases, CM-cellulases, pectinolytic enzymes, cellobiases, exoglucanases, xylanases, and laminarinases. Additionally, in an operation 208, anaerobic conditions can be maintained within the electrochemical cell of the operation 206.

In an operation 210, the generation of electricity occurs when an electric current is created by the migration of electrons through an electrical circuit from the operation 208. Electrons and hydrogen ions are produced as bacteria, i.e., electricigens, metabolize the effluent. As the electrons travel through the wires, the hydrogen ions migrate to the cathode and subsequently form water when oxygen is present. In an operation 212, electricigenic bacteria are added to the electrochemical cell to facilitate the operation 210. In an operation 214, quorum sensing molecules can be added to the operation 212 to enhance biofilm growth and bacterial proliferation. As shown in FIG. 2, maintaining anaerobic conditions in an operation 208 and electricigenic bacterial addition can be performed before or after treating the effluent with cellulolytic enzymes. In an operation 216, wastewater is treated from the operation 214, as electricity is harvested through an external circuit 218.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 proteins refers to groups having 1, 2, or 3 proteins. Similarly, a group having 1-5 proteins refers to groups having 1, 2, 3, 4, or 5 proteins, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

All references cited herein are incorporated by reference in their entireties and for all purposes to the same extent as if each individual publication, patent, or patent application was specifically and individually incorporated by reference in its entirety for all purposes.

What is claimed is:

1. An apparatus for generating electricity comprising:
a first compartment configured to receive an effluent source and including one or more cellulolytic enzymes; and
a second compartment having an electrochemical cell and a biocatalyst capable of oxidizing the effluent, wherein the first compartment is in fluid communication with the second compartment.

2. The apparatus of claim 1, wherein the effluent contains cellulosic biomass from wastewater.

3. The apparatus of claim 1, wherein the one or more cellulolytic enzymes are selected from the group consisting of endoglucanase, cellulase, xylanase, and β-glucosidase.

4. The apparatus of claim 1, wherein the one or more cellulolytic enzymes are immobilized within the first compartment.

5. The apparatus of claim 1, wherein the electrochemical cell contains one or more anodes and at least one cathode connected to an electrical circuit.

6. The apparatus of claim 5, wherein the one or more anodes are carbon cloth anodes or graphite felt anodes, or both.

7. The apparatus of claim 5, wherein the at least one cathode is an air-cathode.

8. The apparatus of claim 1, wherein the biocatalyst is bacteria capable of forming a biofilm in the presence or absence of quorum-sensing inducers.

9. The apparatus of claim 8, wherein the bacteria are Rhodoferax sp. bacteria or Geobacter sp. bacteria selected from the group consisting of G. sulfurreducens and R. ferrireducens, or any combination thereof.

10. The apparatus of claim 1, further comprising a proton exchange membrane.

11. A method for generating electricity comprising:
passing an effluent through a first compartment including one or more cellulolytic enzymes; and
allowing the effluent to flow into a second compartment that includes an electrochemical cell and a biocatalyst capable of oxidizing the effluent, thereby producing the electricity.

12. The method of claim 11, wherein the effluent contains cellulosic biomass from wastewater.

13. The method of claim 11, wherein the one or more cellulolytic enzymes are selected from the group consisting of endoglucanase, cellulase, xylanase, and β-glucosidase, or any combination thereof.

14. The method of claim 11, wherein the one or more cellulolytic enzymes are immobilized within the first compartment.

15. The method of claim 11, wherein the electrochemical cell contains one or more anodes and at least one cathode connected to an electrical circuit.

16. The method of claim 15, wherein the one or more anodes are carbon cloth anodes or graphite felt anodes, or both.

17. The method of claim 15, wherein the at least one cathode is an air-cathode.

18. The method of claim 11, wherein the biocatalyst is bacteria capable of forming a biofilm in the presence or absence of quorum-sensing inducers.

19. The method of claim 18, wherein the bacteria are Rhodoferax sp. bacteria or Geobacter sp. bacteria selected from the group consisting of G. sulfurreducens and R. ferrireducens, or any combination thereof.

20. The method of claim 11, wherein the second compartment further comprises a proton exchange membrane.
